(19) United States
(12) Patent Application Publication
(10) Pub. No.: US 2014/0125061 A1
(43) Pub. Date: May 8, 2014

(54) MODULAR HYDROKINETIC ASSEMBLY

(71) Applicant: Calin BULTOC, (US)

(72) Inventor: Dan Campeanu, Bucharest (RO)

(73) Assignee: Calin BULTOC, Bucharest (RO)

(21) Appl. No.: 14/123,736

(22) PCT Filed: Jun. 5, 2012
(86) PCT No.: PCT/RO2012/000016

§ 371 Date: Jan. 10, 2014

(30) Foreign Application Priority Data
Jun. 3, 2011 (RO) A 2011 00535

(51) Int. Cl. F03B 17/06; F03B 13/10

(52) U.S. Cl. CPC F03B 17/064; F03B 13/10
USPC 290/54; 415/8

(57) ABSTRACT

The invention refers to a modular hydrokinetic assembly which allows the conversion of the kinetic energy of flowing waters into useful mechanical energy for driving some electric generators or water pumping sets, without building dams or culverts. The modular hydrokinetic assembly according to the invention comprises two lower and upper underframes (1 and 2) and a blade assembly (3) formed of two endless chains comprising the plates (20) whereon blades (21) are fastened and actuated by the water of a river, caught from a river by means of a threshold and catching connector and, transmit the mechanical energy by means of a star wheel (23), secured on the axles of electrical generators (4) or water pumping sets (5), the amount of the resulting mechanical energy being dependent mainly on the water flow rate and slope of the channel formed by the lower underframe (1) and, by the radius described by the blades (21) to the axles of the star wheels (23).

The invention refers to a modular hydrokinetic assembly which allows the conversion of the kinetic energy of flowing waters into useful mechanical energy for driving some electric generators or water pumping sets, without building dams or culverts.

In order to convert the kinetic energy of flowing waters into mechanical energy, without building dams or culverts, several constructions are known, such as blade wheels with lower or upper admission, immersed blade chains systems and Archimedean screw sets, yet with some drawbacks, namely:
they require water flow rates and slopes with comparatively large level differences, thus limiting their applicability range;
in some blade chains systems, they transmit the water energy by means of hinges, thus reducing their reliability;
as channels dimensioned in accordance with the flowing characteristics of water are not provided, the blade systems have a reduced efficiency and a reduced energetic capacity;

The problem that the invention seeks to solve consists in carrying out a modular hydrokinetic assembly driven by the water flowing at a low flow rate, on a slope with a small level difference, provided by a simple hydro-technical arrangement.

The modular hydrokinetic assembly according to the invention removes the above drawbacks in that it is provided with a water flow channel that acts by means of blades on the entire kinematical chain, the gaps between blades and the walls of said channel being sealed by simple seals which reduce at a minimum the hydraulic losses during functioning and, the assembly reliability is ensured by constructive solutions that are encompassed by the present invention.

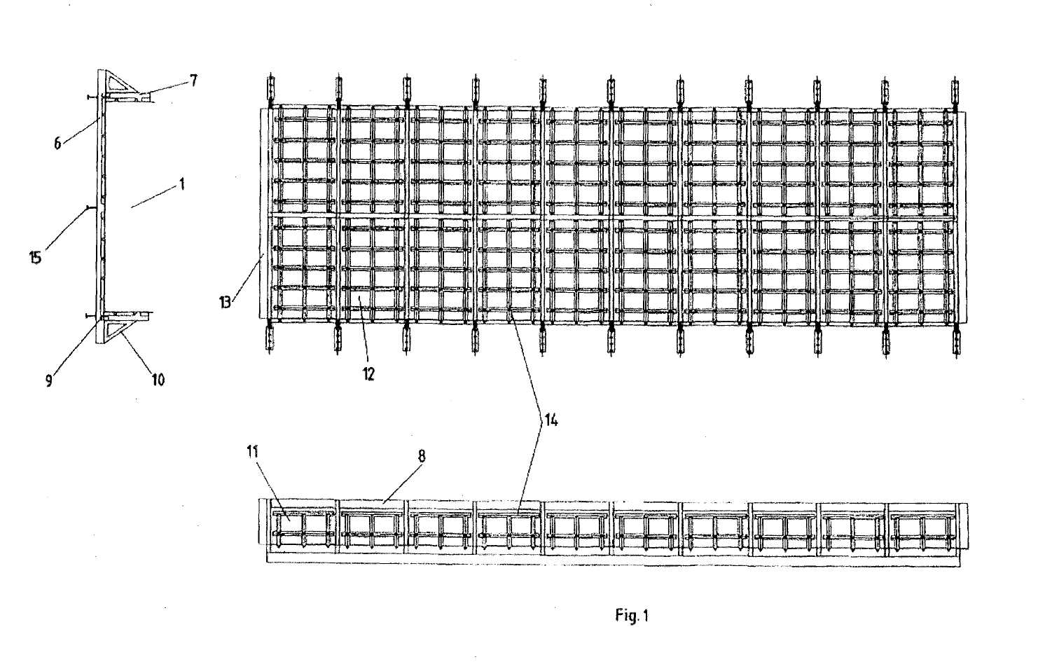

An embodiment example of the invention is given below, in relation with FIGS. 1 to 5, representing:

FIG. 1, the lower underframe;

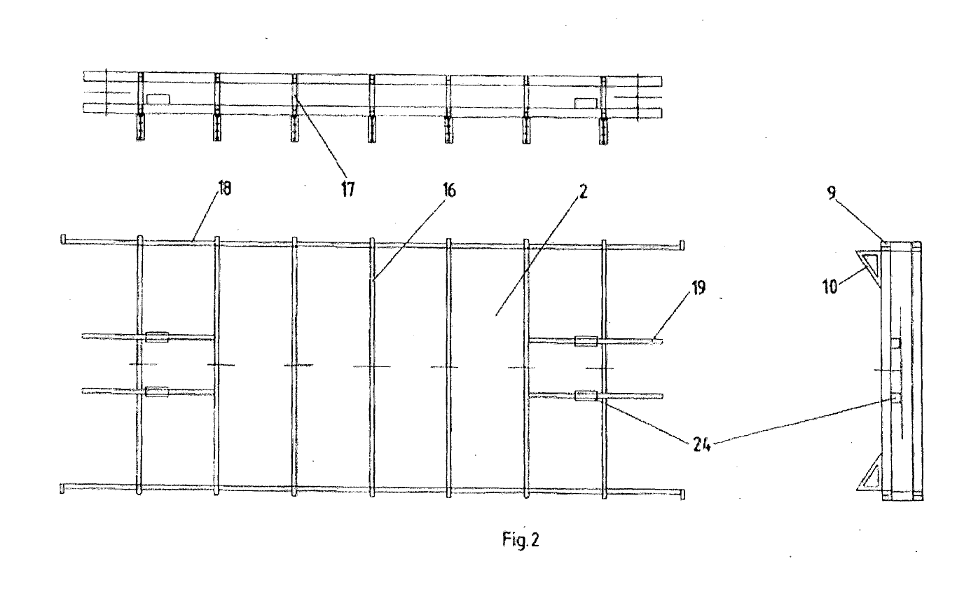

FIG. 2, the upper underframe;

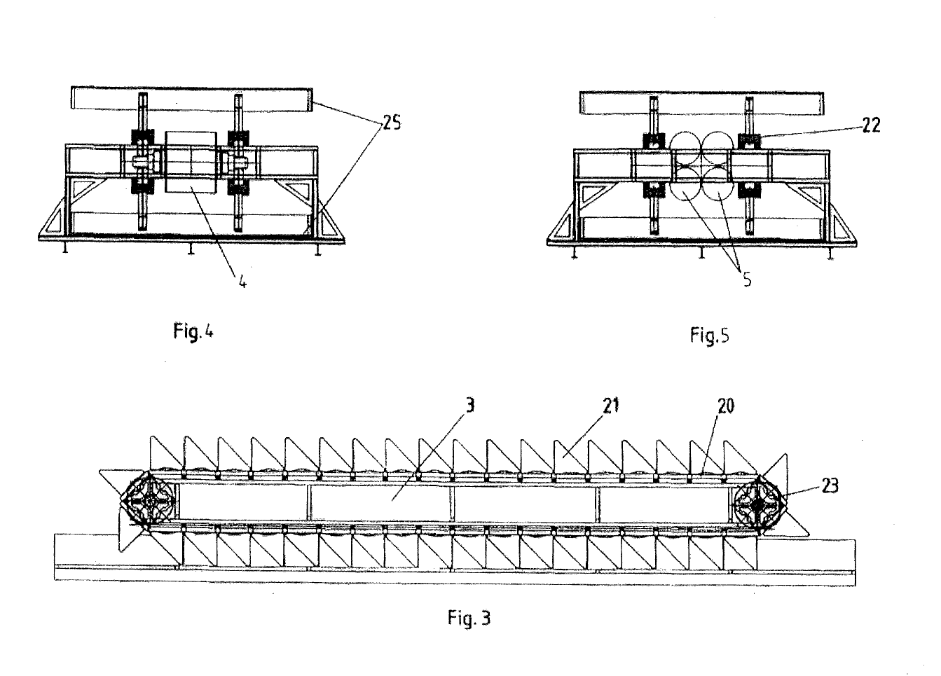

FIG. 3, lateral view of the blade assembly;

FIG. 4, the section with electric generators;

FIG. 5, the section with water pumping sets.

According to the invention, the modular hydrokinetic assembly comprises a lower underframe (1), an upper underframe (2) and a blade assembly (3) which converts the water kinetic energy, caught from a river by means of a threshold and catching connectors, into mechanical energy useful for driving the electric generators (4) or the water pumping sets (5).

The lower underframe (1) comprises several cross-beams (6) and framings (7), assembled therebetween as modules, by means of spacers (8), cut-out fastening members (9) and cutout strengthening members (10).

On said cross-beams and framings side walls (11) and foundation (12) are fastened, forming a channel through which the water flowing in a river, caught by a threshold in a catching connector, is oriented to flow acting on the assembly blades (3), at the ends the channel being provided with sealing members (13) for connecting it either to the water connector, or to another modular hydrokinetic assembly.

The lateral walls and the foundation of said channel are made of modular panels reinforced by stiffening profiles (14) which do not allow the underframe distortion under mechanical stress, and said cross-beams (6) are mounted on several sills (15) which allow the fastening of the underframe on a base.

The upper underframe (2) comprises several cross-beams (16) and spacers (17), fastened therebetween with spacers (18) by means of cut-out fastening members (9) and, said cross-beams (16) support the guide members (21) allowing the movement of the blade assembly (3) and, at the ends of the upper underframe (2), the brackets (19) are provided, supporting the electrical generators or pumping sets.

The upper underframe (2) is mounted on the lower underframe (1) by means of cut-out fastening members (9) and cut-out strengthening members (10).

The blade assembly (3) is formed of two endless chains comprising the plates (20), whereon blades (21) are fastened, said blades move through the guide members (22) and engage some star wheels (23) fastened on the axles belonging to electrical generators or pumping sets.

For a correct functioning, the brackets (19) are provided with adjusting members (24) allowing the adjustment of positions for the electrical generators or pumping sets and the corresponding length of the plate chains.

In order to reduce the hydraulic losses by gaps between blades (21), the side walls (11) and foundation (12) on the active outline of said plates, the elastic strips (25) are provided, having a sealing function.

The modular hydrokinetic assembly presents a series of essential advantages with respect to the reliability in use and the developing of the applicability field of the invention:
it allows the exploitation of the energetic potential of rivers flowing in the plain regions, where the flat relief does not allow the building of dams or culverts, in economic conditions;
it effectively functions with low slopes and water flow rates, thus increasing the applicability range of the modular hydrokinetic assembly;
said blades are rigidly secured on the plate chain, excluding the possibility of a mobile arrangement, thus increasing the reliability of the modular hydrokinetic assembly;
due to its modular characteristic, it can be configured in a diversified dimensional range;
the construction of hydro-technical arrangements is simplified as the channel for machining river waters are incorporated into the modular hydrokinetic assemblies;
at the ends, the modular hydrokinetic assembly is provided with members for connecting to the catching connector and to the next assembly, so as a cascade connection can be easily made from several modular hydrokinetic assemblies, in view of increasing the total energetic capacity of the hydro-technical arrangement whereon they will be installed.

1-7. (canceled)

8. A modular hydrokinetic assembly wherein, it comprises:
a lower underframe (1) which comprises several cross-beams (6) framings (7) assembled therebetween modules, wherein side walls (11) and foundation (12) are fastened on said cross-beams (6) and said framings (7), said side walls (11) and foundation (12) forming a channel, which channel is provided at its ends with sealing members (13) for connecting it either to the water connector, or to another modular hydrokinetic assembly;
an upper underframe (2) mounted on the lower underframe (1), wherein brackets (19) are provided on the ends of said upper underframe (2), supporting the electrical generators or water pumping sets, and
a blade assembly (3) formed of two endless chains comprising the plates (20) whereon blades (23) are fastened and which engage some star wheels (24) fastened on the axles belonging to electrical generators or pumping sets.

9. The modular hydrokinetic assembly according to claim 8, wherein the cross-beams (6) and framings (7) which form the a lower underframe (1), are assembled therebetween as modules by means of spacers (8), cut-out fastening members (9) and cut-out strengthening members (10).

10. The modular hydrokinetic assembly according to claim 8, wherein the side walls (11) and the foundation (12) forming the said channel, are made of modular panels reinforced by stiffening profiles (14) which do not allow the underframe distortion under mechanical stress and, said cross-beams (6) are mounted on sills (15) which allow the fastening of the lower underframe. (1) on a base.

11. The modular hydrokinetic assembly according to claim 8, wherein the upper underframe (2) comprises several cross-beams (16) and spacers (17), fastened therebetween modules with spacers (18) by means of cut-out fastening members (9).

12. The modular hydrokinetic assembly according to claim 8, wherein the upper underframe (2) is mounted on the lower underframe (1) by means of cut-out fastening members (9) and cut-out strengthening members (10) and said crossbeams (16) support the guide members (21) allowing the movement of said plates (20).

13. The modular hydrokinetic assembly according to claim 8, wherein for a correct functioning, the brackets (19) which support the electrical generators or water pumping sets on the ends of said upper underframe (2), are provided with adjusting members (25) allowing the adjustment of positions tier the electrical generators or pumping sets and the corresponding elongation of the plate chains.

14. The modular hydrokinetic assembly according to claim 8, wherein for reducing the hydraulic losses through the gaps formed between blades (21), the side walls (11) and the foundation (12), there are provided elastic strips (25) with sealing function on the active outline of said plates (20).
